(19) United States
(12) Patent Application Publication
(10) Pub. No.: US 2006/0047570 A1
(43) Pub. Date: Mar. 2, 2006

(54) Apparatus, system, and method for preventing fraudulent reuse of a voucher

(76) Inventors: David H. Lenderking, Holly Springs, NC (US); Deidre Maskaleris Lenderking, Holly Springs, NC (US)

Correspondence Address: KUNZLER & ASSOCIATES, 8 EAST BROADWAY, SUITE 600, SALT LAKE CITY, UT, 84111, US

(21) Appl. No.: 10/933,085

(22) Filed: Sep. 2, 2004

(51) Int. Cl. G06Q 30/00

(52) U.S. Cl. 705/14

(57) ABSTRACT

An apparatus, system, and method are disclosed for preventing fraudulent reuse of a voucher. Voucher misredemption is responsible for more than $300 million of retail losses annually. The apparatus provides a reader that reads an electromagnetic (EM) identifier attached to a voucher, an authentication module that validates the voucher, and an invalidation module that invalidates the identifier upon expiration of the voucher. A storage device may also store information about the identifier, and the location of redemption for purposes of marketing and distribution management.

### BACKGROUND OF THE INVENTION

1. Field of the Invention

This invention relates to fraud prevention and more particularly relates to preventing fraudulent reuse of a voucher.

2. Description of the Related Art

According to the Coupon Information Corporation (CIC), “Coupon misredemption costs consumer product manufacturers hundreds of millions of dollars every year. Estimates of this cost vary from a low of about $300 million annually to more than twice that amount” (From the World Wide Web at cents-off.com). Coupon misredemption is the act of fraudulently reusing coupons after initial redemption of the coupon. Coupons are not the only type of voucher that may be redeemed fraudulently. Other types of vouchers that may be redeemed fraudulently include event admission tickets, travel vouchers, and certain negotiable instruments including checks.

Methods for preventing fraudulent reproduction and distribution of vouchers via the Internet have recently been implemented, but the vast majority of coupons in distribution are printed coupons. Printed coupons include those found in newspapers, coupon distribution mailers, retailer ads, and the like. Currently, no effective method for preventing fraudulent misredemption of paper vouchers or other vouchers generally exists.

The majority of paper vouchers are tracked by a Universal Product Code (UPC) bar code. These bar codes are not very effective in preventing fraudulent reuse of vouchers because they are not deactivated upon initial use. If the voucher is not surrendered at time of purchase, it can be used over and over again. It may even be possible to use vouchers with bar codes after the expiration date.

Generally retailers require that the customer surrender the voucher at the time of purchase. This method does help prevent fraudulent reuse of vouchers, but the growing use of self-serve check stands is making this method difficult to implement. If a retailer employee is available to monitor the self-serve check stands, he generally has multiple check stands to monitor at once. Consequently, the employee may not prevent a customer from retaining a redeemed voucher. For this reason, it is becoming increasingly difficult for retailers to monitor and control fraudulent reuse and misredemption of vouchers.

From the foregoing discussion, it should be apparent that a need exists for an apparatus, system, and method that prevents fraudulent reuse of a voucher. Beneficially, such an apparatus, system, and method would read the voucher, authenticate the voucher, and deactivate the voucher upon redemption, expiration, or authorization from the manufacturer.

### SUMMARY OF THE INVENTION

The present invention has been developed in response to the present state of the art, and in particular, in response to the problems and needs in the art that have not yet been fully solved by currently available voucher fraud prevention methods. Accordingly, the present invention has been developed to provide an apparatus, system, and method for preventing fraudulent reuse of a voucher that overcome many or all of the above-discussed shortcomings in the art.

The apparatus to prevent fraudulent reuse of a voucher is provided with a logic unit containing a plurality of modules configured to functionally execute the necessary steps of reading an identifier connected to the voucher, validating the voucher, and invalidating the identifier responsive to expiration of the voucher. These modules in the described embodiments include a reader, an authentication module, and an invalidation module.

Preferably, the reader is configured to read an identifier connected to the voucher. In one embodiment, the identifier comprises an electromagnetic (EM) identifier. The identifier may respond to either electric fields or magnetic fields. The identifier uniquely identifies the voucher and comprises at least one attribute selected from a group consisting of an expiration date, a manufacturer identifier, a product identifier, and a serial number. In another embodiment, the reader is integrated with a Point of Sale (POS) system. The attributes of the unique identifier allow the POS system to immediately determine the validity, and allow each voucher to be associated with a specific product and manufacturer.

Preferably, the authentication module is configured to validate the voucher. In one embodiment, the authentication module communicates a message derived from the identifier to a repository of authentication information, and receives an acknowledgement that the message matches authentication information in the repository. The apparatus may further comprise a storage module configured to store marketing information related to the voucher including a location for voucher redemption, the unique identifier information, and data regarding the redemption derived from a combination of the location of redemption and the unique identifier information. In another embodiment, the storage module may also store a timestamp, existing distribution information associated with the identifier, and the like.

Preferably, the invalidation module is configured to invalidate the identifier responsive to expiration of the voucher. Expiration may include passing of an expiration date, redemption of the voucher, cancellation of the voucher, and the like. In one embodiment, the invalidation module is further configured to disable the identifier in response to a command from a controller. The invalidation module may be further configured to logically void the voucher. Logically voiding the voucher may comprise setting a flag in authentication information defined for the voucher.

In one embodiment, the apparatus to prevent fraudulent reuse of a voucher includes a microprocessor configured to modulate an EM field and attach an authentication message, a transmitter configured to transmit the modulated message to a remote device, and a receiver configured to receive an invalidation command.

A system of the present invention is also presented to prevent fraudulent reuse of a voucher. The system may include a voucher with an attached EM identifier, an EM scanner comprising a reader, an authentication module, and an invalidation module, a POS system in communication with the EM scanner, and a repository of authentication information. In one particular embodiment, the system may include a storage device configured to store information related to the voucher derived from the unique identifier and a location of redemption.

A method of the present invention is also presented for preventing fraudulent reuse of a voucher. The method in the disclosed embodiments substantially includes the steps necessary to carry out the functions presented above with respect to the operation of the described apparatus and system.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for preventing fraudulent reuse of a voucher;

FIG. 2 is a schematic block diagram of an apparatus for preventing fraudulent reuse of a voucher;

FIG. 3 is a schematic block diagram of a method for preventing fraudulent reuse of a voucher;

FIG. 4 is a detailed schematic block diagram of a method for preventing fraudulent reuse of a voucher; and

FIG. 5 is a schematic block diagram of an electromagnetic identifier attached to a voucher.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

The schematic flow chart diagrams included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

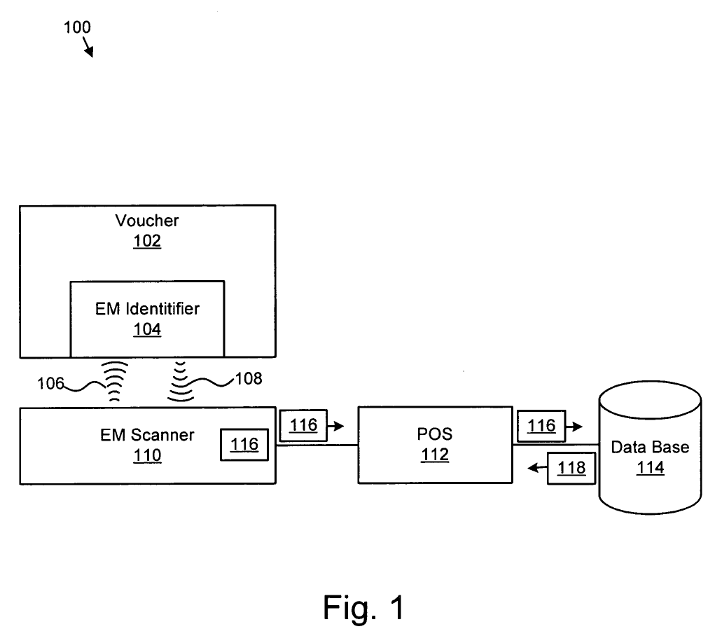

FIG. 1 depicts a schematic block diagram of a system 100 for preventing fraudulent reuse of a voucher 102. In one embodiment, the system 100 includes an EM scanner 110 which communicates with a POS system 112. The POS system 112 may also communicate with a data repository 114 such as a database. The system 100 may also include a voucher 102 with an attached EM identifier 104. One example of an EM identifier 104 is an inductively coupled Radio Frequency Identifier (RFID). Inductively coupled means the amount of electricity is directly related to the strength of the magnetic field. Another example of an EM identifier is a capacitively coupled RFID. Capacitively coupled means that the amount of energy available, known as voltage, is directly related to the strength of the electric field around the RFID. The RFID may be disabled if the identifier electronics are not allowed to interact with the electric and magnetic fields.

In one embodiment, the EM scanner 110 communicates with the EM identifier 104 attached to the voucher 102 via EM signals 106,108. An EM signal may be embodied as EM waves or static EM fields. The frequencies used for the EM identifier 104 may vary based on the local standards and geographic regulations. Preferably, the frequency selected for the EM identifier 104 may range anywhere between about 13.56 MHz and about 2.4 GHz. More specifically, the EM identifier 104 may be selected from one of several common RFID frequencies including about 13.56 MHz, about 915 MHz, and about 2.4 GHz. The EM scanner 110 emits an EM signal 106 which is received by the EM identifier 104. In one embodiment, the EM identifier 104 modulates the received EM signal 106 and transmits a modulated response signal 108. The EM identifier 104 modulates the received EM signal by introducing amplitude or frequency fluctuations to the signal. The EM scanner 110 may receive the response signal 108, and interpret a message 116 from the modulated signal. In one embodiment, the emitted EM signal 106 and the response EM signal 108 are electric fields. In an alternative embodiment, the emitted EM signal 106 and the response EM signal 108 are magnetic fields. Alternatively, the EM signals 106, 108 may be light, X-rays, nuclear radiation, or other types of signals that exhibit EM wave properties. In various embodiments, the EM signals 106, 108 may be of any frequency from a static field or standing signal to beyond the frequencies of the visible light spectrum.

In one embodiment, the EM scanner 110 communicates an interpreted message 116 to a POS system 112. In response, the POS system 112 may send an authentication query that includes the message 116 to the data repository 114. The data repository 114 responds to the query from the POS system 112 with a response message 118.

If the message 116 from the EM identifier 104 matches the response message 118 in the data repository 114 indicating that the voucher is valid, the POS system 112 processes the transaction. Examples of transactions include redemption of the voucher as legal tender, discounting an associated item, admission to an event, and the like. In one embodiment, the POS system 112 is a cash register. In an alternative embodiment, the POS system 112 is a computer. Alternatively, the POS system 112 may be a hybrid of a cash register and a computer. The data repository 114 may be a remote data base. Alternatively, the data repository 114 is a storage device such as a disk, tape, or memory local to the POS system 112.

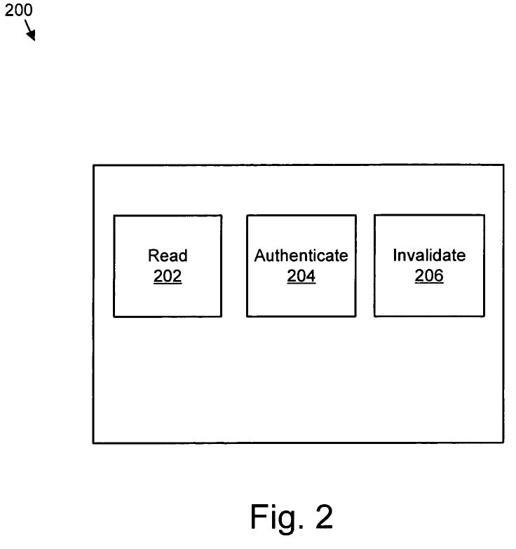

FIG. 2 is a schematic block diagram of an apparatus 200 for preventing fraudulent reuse of a voucher 102. The apparatus 200 includes a reader 202, an authentication module 204, and an invalidation module 206. In one embodiment, these modules are collocated in an enclosure separate from the POS system 112. In an alternative embodiment, these modules are integrated with a POS system 112. In another alternative embodiment, the modules are distributed between the scanner 110, the POS system 112, and the data repository 114.

The reader 202 reads an identifier connected to a voucher 102. The reader 202 may include electronic components required to generate, transmit, and receive an electromagnetic signal. These components may include a power source, a signal frequency source, a transmit antenna, a receive antenna, a power amplifier, a demodulator, a decoder, and the like. Preferably, the reader is implemented by the EM scanner 110. The frequencies used for the EM identifier 104 may vary based on the local standards and geographic regulations. Preferably, the frequency selected for the EM identifier 104 may range anywhere between about 13.56 MHz and about 2.4 GHz. More specifically, the EM identifier 104 may be selected from one of several common RFID frequencies including about 13.56 MHz, about 915 MHz, and about 2.4 GHz. The reader 202 may be integrated with a POS system 112. In one embodiment, the reader 202 demodulates the response signal 108 and converts the demodulated signal into a digital message 116. In another embodiment, the reader 202 induces the EM identifier 104 to respond by emitting an electric field. Alternatively, the reader 202 may emit a magnetic field, light field, or another field that exhibits electromagnetic properties.

The authentication module 204 validates the voucher 102. In one embodiment, the authentication module 204 sends a message 116 generated by the reader 202 to a data repository 114 for processing. The authentication module 204 may send the message 116 via a communication channel. In one embodiment, the communication channel is a wired connection. In an alternative embodiment, the communication channel is wireless. The communication channel may transfer digital signals. Alternatively, the communication channel may transfer analog signals. The authentication module 204 may also receive an acknowledgement 118 that the message 116 derived from the EM identifier 104 matches authentication information in the repository 114 via the communication channel. If there is a match, the authentication module 204 validates the voucher 102. If there is no match, the voucher 102 is not authentic and therefore expired.

In one embodiment, the invalidation module 206 invalidates the EM identifier 104 in response to expiration of the voucher 102. The invalidation module 206 may invalidate the EM identifier 104 by sending a kill command understandable to the EM identifier 104. A kill command renders the EM identifier 104 temporarily useless. Those of skill in the art will recognize various ways to implement a kill command that temporarily disables the identifier. The kill command may also reset internal data storage in the EM identifier 104, clearing any stored data. Advantageously, the kill command prevents reuse of the voucher 102. In subsequent attempts to redeem the voucher 102, the identifier 104 is unresponsive. Consequently, the scanner 110 fails to register the identifier 104 and no fraudulent credit or voucher benefit is provided.

Alternatively, the invalidation module 206 may send a self-destruct command to the EM identifier 104, which completely destroys the identifier 104. One example of a self-destruct command is a high energy pulsed emission which shorts the electronics in the EM identifier 104. The self-destruct command may short electrical components in the EM identifier 104. The kill command simply resets or temporarily disables the EM identifier 104, while the self-destruct command irreparably destroys the EM identifier 104.

Certain embodiments of the presented invention may more suitably use a kill command, a self-destruct command, or a logical voiding (discussed below) to invalidate the voucher 102. For example, reusable vouchers 102 for discount admission to an amusement park may be issued a kill command at the end of a summer season. The same vouchers 102 may be reused by issuing an awaken command once a patron has paid for a subsequent season.

The invalidation module 206 may issue a self-destruct command to disposable vouchers 102 such as coupons that include attached identifiers 104. Once invalidated, discarded vouchers 102 will be almost technically impossible to misredeem. IN this manner, the present invention technically prevents misredemption of vouchers 102.

Alternatively, the invalidation module 206 may invalidate the identifier by logically voiding the identifier 104. Logically voiding the identifier 104 may include setting a flag in the data repository 114 with the identifier data indicating that the identifier has expired. With the flag set, the authentication module 204 will not validate the voucher 102. In one embodiment, the authentication module 204 may signal a warning that misredemption is being attempted. Logically voiding the EM identifier 104 does not affect operation of the EM identifier 104 physically.

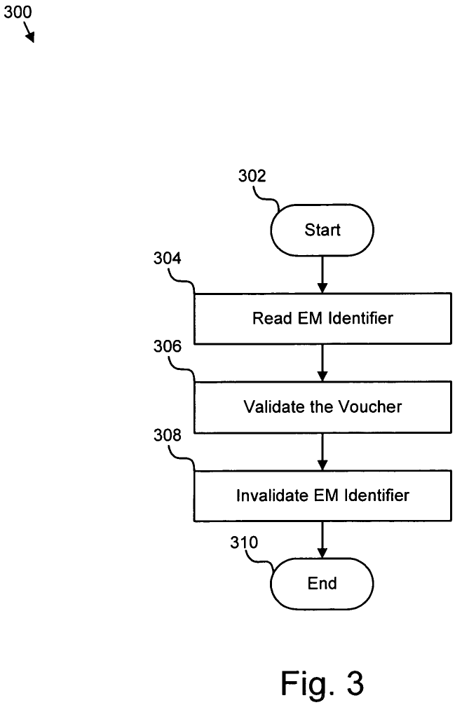

FIG. 3 is a schematic flow diagram of a method 300 for preventing fraudulent reuse of a voucher 102. The method 300 starts 302 when the reader 202 reads 304 an EM identifier 104 connected to a voucher 102. The voucher 102 may be read 304 by putting the voucher 102 in close proximity with the EM scanner 110. Then, the authentication module 204 authenticates 306 the voucher 102. Upon expiration of the voucher 102, the invalidation module 206 invalidates 308 the voucher 102, and the method ends 310. Expiration may include passing of an expiration date, previous redemption of the voucher, cancellation of the voucher, and the like.

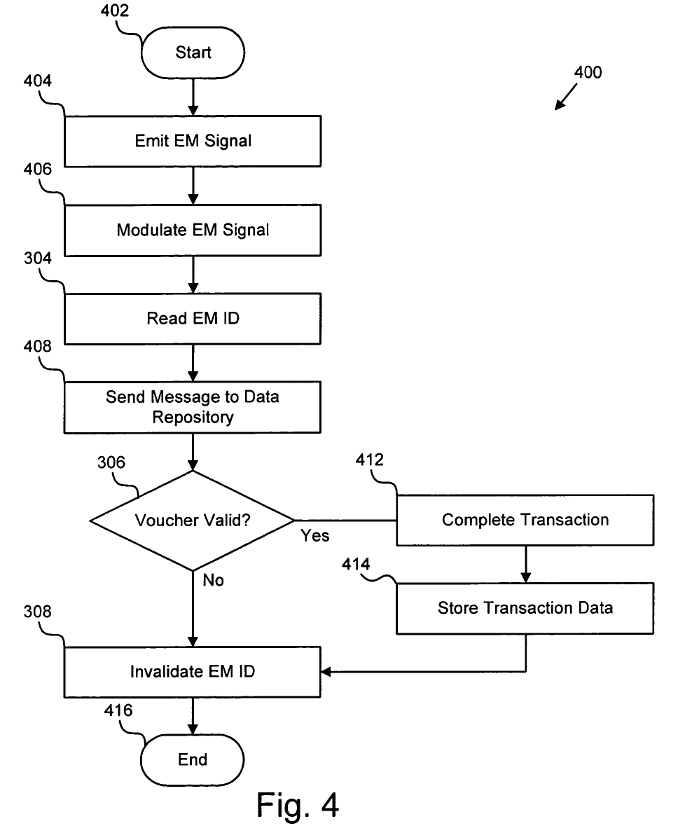

FIG. 4 is a detailed schematic flow diagram of a method 400 for preventing fraudulent reuse of a voucher 102. The method 400 starts 402 when the reader 202 emits 404 an electromagnetic field. The electromagnetic field may be emitted 404 continuously. Alternatively, the electromagnetic field may be initiated by a POS system 112. The EM identifier 104 modulates 406 and transmits the EM field back to the reader 202. The EM identifier 104 may code a unique identifier in the EM field as a modulation pattern. The modulation pattern may be coded by fluctuating the signal in a specific pattern associated with binary information stored on the EM identifier 104. For example, the signal amplitude may be high for a ‘1’ bit, and low for a ‘0’ bit.

The reader 202 reads 304 the message 116 (the unique identifier represented by the fluctuating signal) from the EM identifier 104, and sends 408 the message 116 to the data repository 114. The reader 202 may send 408 the message 116 directly to the data repository via a network connection. Alternatively, the reader 202 may send 408 the message 116 through the POS system 112.

The authentication module 206 validates 306 the voucher 102 with data stored in the data repository 114. The message 116 may include product information, a serial number, an expiration date, and the like. The data repository 114 may include information regarding the expiration data for the voucher, a history of voucher redemption, a flag indicating whether a voucher is expired, and the like. In one embodiment, the message 116 is compared with the data in the data repository 114. If, for example, the expiration date indicated in the message 116 matches the expiration date in the data repository 114 for the voucher 102 of the identified serial number, and the expiration date has not passed, the data repository 114, may send an acknowledgement 118 indicating that the voucher 102 is valid.

Next, a determination 306 is made whether the voucher 102 is valid using the EM identifier 104. If the EM identifier 104 is valid, the POS 112 completes 412 the transaction. Alternatively, if a flag has been set in the data repository 114 indicating that the voucher of the specified serial number has already been redeemed, then the data repository 114 may send an acknowledgment 118 indicating that the voucher 102 has expired. In such an embodiment, the invalidation module 206 may send an immediate kill command to the EM identifier 104. In one embodiment, the POS system 112 may store 414 transaction data in a storage device.

Once the transaction data has been stored 414, or if the EM identifier 104 found to be not valid, the invalidation module 206 may physically or logically invalidate 308 the EM identifier 104 and the method ends 416. If, the invalidation module 206 invalidates 308 the EM identifier 104 by logically voiding the identifier, a flag in the data repository 114 may be set indicating expiration of the voucher.

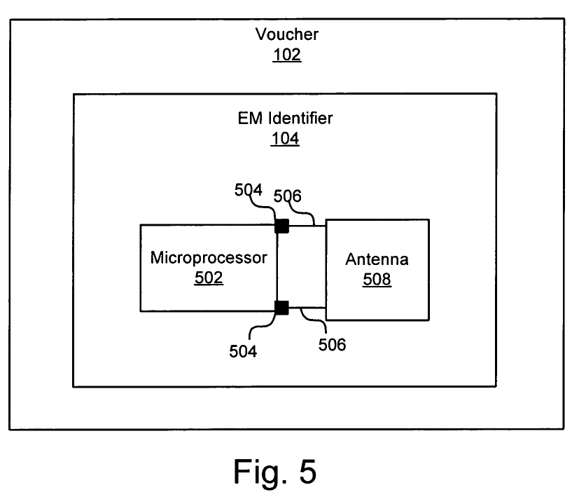

FIG. 5 is a schematic block diagram of an exemplary EM identifier 104 attached to a voucher 102. In one embodiment, the EM identifier 104 includes a microprocessor 502, electrical contacts 504, and an antenna 508 connected to the electrical contacts 504 by electrical connections 506. In one alternative embodiment, the EM identifier 104 may also include a power source such as a battery. In one embodiment, the EM identifier 104 is inductively coupled. Alternatively, the EM identifier 104 may be capacitively coupled.

In one embodiment, the microprocessor 502 is a silicon chip. Various microfabrication techniques may be employed to etch a microelectronic circuit onto a thin silicon wafer. In one embodiment, the microprocessor 502 requires an active power source such as a battery. Alternatively, the microprocessor 502 may be powered passively with an applied electromagnetic field. In one embodiment, the microprocessor 502 is configured to be Electronic Product Code (EPC) compliant. The microprocessor 502 can code the signal 108 within a message 116 that is of an appropriate number of bits and includes specified information to qualify for EPC compliance.

The antenna 508 may be both the transmitter and the receiver. The antenna 508 receives an electric or magnetic signal from the EM scanner 110, and transmits a signal back to the EM scanner 110 on the same antenna without interference. In one embodiment, the antenna 508 is a metal coil. The antenna 508 may be made of copper or aluminum wire. A wire coil will conduct electrical current upon application of a magnetic field, and will emit a magnetic field upon application of an electrical current. Alternatively, the antenna 508 may be a capacitive antenna such as a dipole or microstrip antenna. In one embodiment, the antenna 508 is printable. The antenna 508 may be printed by applying a conductive carbon based ink.

The antenna 508 is connected to the microprocessor 502 via the connection of the electrical connections 506 to the electrical contacts 504. In one embodiment, the electrical connections 506 are printed using conductive carbon ink. In an alternative embodiment, the electrical connections 506 are metal wires or strips. In one embodiment, the electrical contacts 504 are a metal conductor deposited on a silicon substrate and attached to the silicon microprocessor. In an alternative embodiment, the electrical contacts 504 are attached with a conductive joining material. One example of a conductive joining material is solder.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to prevent fraudulent reuse of a voucher, the apparatus comprising:
a reader configured to read an identifier connected to a voucher;
an authentication module configured to validate the voucher; and
an invalidation module configured to invalidate the identifier responsive to expiration of the voucher.

2. The apparatus of claim 1, wherein the identifier comprises an electromagnetic identifier.

3. The apparatus of claim 1, wherein the reader is integrated with a point of sale (POS) system.

4. The apparatus of claim 1, wherein authentication module communicates a message derived from the identifier to a repository of authentication information, and receives an acknowledgement that the message matches authentication information in the repository.

5. The apparatus of claim 1, wherein the invalidation module is further configured to disable the identifier in response to a command from a controller.

6. The apparatus of claim 1, wherein the invalidation module is further configured to logically void the voucher.

7. The apparatus of claim 6, wherein logically voiding the voucher comprises setting a flag associated with authentication information defined for the voucher.

8. The apparatus of claim 1, wherein the identifier uniquely identifies the voucher and comprises at least one attribute selected from a group consisting of an expiration date, a manufacturer identifier, a product identifier, and a serial number.

9. The apparatus of claim 1, further comprising a storage module configured to store context information related to the voucher derived from the unique identifier and a location of redemption.

10. An apparatus to prevent fraudulent reuse of a voucher, the apparatus comprising:
a microprocessor configured to modulate an electromagnetic (EM) field and attach an authentication message;
a transmitter configured to transmit the modulated authentication message to a remote device; and
a receiver configured to receive an invalidation command.

11. The apparatus of claim 10, further configured to disable itself in response to a command from a controller.

12. The apparatus of claim 10, wherein the authentication message identifies the voucher and comprises at least one attribute selected from a group consisting of an expiration date, a manufacturer identifier, a product identifier, and a serial number.

13. A system to prevent fraudulent reuse of a voucher, the system comprising:
a voucher with an attached electromagnetic (EM) identifier;
an EM scanner comprising;
a reader configured to read an identifier connected to a voucher;
an authentication module configured to validate the voucher;
an invalidation module configured to invalidate the identifier responsive to expiration of the voucher.
a Point of Sale (POS) system in communication with the EM scanner; and
a repository of authentication information.

14. The system of claim 13, wherein the reader is integrated with the point of sale (POS) system.

15. The system of claim 14, wherein authentication module communicates a message derived from the identifier to a repository of authentication information, and receives an acknowledgement that the message matches authentication information in the repository.

16. The system of claim 15, wherein the invalidation module is further configured to disable the identifier in response to a command from a controller.

17. The system of claim 16, wherein the invalidation module is further configured to logically void the voucher, wherein logically voiding the voucher comprises setting a flag associated with authentication information defined for the voucher.

18. The system of claim 17, wherein the identifier uniquely identifies the voucher and comprises at least one attribute selected from a group consisting of an expiration date, a manufacturer identifier, a product identifier, and a serial number.

19. The system of claim 18, further comprising a storage device configured to store context information related to the voucher derived from the unique identifier and a location of redemption.

20. A signal bearing medium tangibly embodying a program of machine-readable instructions executable by a digital processing apparatus to perform operations for preventing fraudulent reuse of a voucher, the operation comprising:
reading an identifier connected to the voucher;
authenticating the identifier to validate the voucher; and
invalidating the identifier responsive to expiration of the voucher.

21. The signal bearing medium of claim 20, wherein the identifier comprises an electromagnetic identifier.

22. The signal bearing medium of claim 20, wherein the operation to read the identifier is carried out by a reader integrated with a point of sale (POS) system.

23. The signal bearing medium of claim 20, wherein the operation to authenticate further comprises communicating a message derived from the identifier to a repository of authentication information, and receiving an acknowledgement that the message matches authentication information in the repository.

24. The signal bearing medium of claim 20, wherein the operation to invalidate further comprises disabling the identifier in response to a command from a controller.

25. The signal bearing medium of claim 20, wherein the operation to invalidate further comprises logically voiding the voucher.

26. The signal bearing medium of claim 25, wherein logically voiding the voucher comprises setting a flag associated with authentication information defined for the voucher.

27. The signal bearing medium of claim 20, wherein the identifier uniquely identifies the voucher and comprises at least one attribute selected from a group consisting of an expiration date, a manufacturer identifier, a product identifier, and a serial number.

28. The signal bearing medium of claim 20, wherein the instructions further comprise an operation to store context information related to the voucher derived from the unique identifier and a location of redemption.

29. A method for preventing fraudulent reuse of a voucher, the method comprising:
reading an identifier connected to the voucher;
authenticating the identifier to validate the voucher; and
invalidating the identifier responsive to expiration of the voucher.

30. An apparatus to prevent fraudulent reuse of a voucher, the apparatus comprising:
means for reading an identifier connected to the voucher;
means for authenticating the identifier to validate the voucher; and
means for invalidating the identifier responsive to expiration of the voucher.
